(19) United States
(12) Patent Application Publication
(10) Pub. No.: US 2015/0047207 A1
(43) Pub. Date: Feb. 19, 2015

(54) CHAMFERING TOOL

(71) Applicant: Stanley Black & Decker, Inc., New Britain, CT (US)

(72) Inventor: Aliaksei Chernyshou, Farmington, CT (US)

(21) Appl. No.: 13/967,611

(22) Filed: Aug. 15, 2013

(51) Int. Cl. B26B 29/06; B28D 1/30

(52) U.S. Cl. CPC B26B 29/06; B28D 1/30
USPC 30/169

(57) ABSTRACT

A chamfering tool comprising: a base having first and second walls meeting each other along a longitudinal axis and defining a longitudinal recess along the bottom of the base for engaging a work piece and a longitudinal ridge along the top of the base; a viewing window in the base for viewing the work piece, the viewing window intersecting the longitudinal recess and the longitudinal ridge; and a blade clamp mounted on the base and arranged to clamp at least part of a blade in the viewing window.

### FIELD OF THE INVENTION

The present invention relates to a chamfering tool.

### BACKGROUND OF THE INVENTION

With the current population growth in the world today there is great importance on constructing new buildings for a variety of purposes. New construction techniques often require efficient processes for a quicker build time. One such technique is to use drywall (also known as plasterboard) panels in the interior fitting of the building. The drywall panel provides a premade surface for the interior of the building which can be decorated with minimal treatment beforehand. One such use of drywall panels is in the interior layout of the building whereby interior walls are constructed from a lightweight timber frame and the drywall panels are fixed to the timer frame.

Drywall is manufactured in large rectangular panels but often the drywall must be worked and shaped before use. For example if two pieces of drywall are required to meet at a corner, a 45 degree chamfer can be made on each drywall piece. The chamfers are then arranged to be placed adjacent to each other and provide a flush 90 degree corner.

A known tool for cutting a chamfer is shown in U.S. Pat. No. 316,079 which shows plane with a gage having two flat surfaces meeting at a right angle. The right angle runs longitudinally and engages flat surfaces at the edge of the work piece. A problem with the plane is that the blade and the gage must be adjusted before chamfering a corner of a panel. The user may also have difficulty initially aligning the edge of the work piece with the gage to ensure a clean chamfer.

### BRIEF SUMMARY OF THE INVENTION

Embodiments of the present invention aim to address the aforementioned problems.

According to an aspect of the present invention there is a chamfering tool comprising: a base having first and second walls meeting each other along a longitudinal axis and defining a longitudinal recess along the bottom of the base for engaging a work piece and a longitudinal ridge along the top of the base; a viewing window in the base for viewing the work piece, the viewing window intersecting the longitudinal recess and the longitudinal ridge; and

A blade clamp mounted on the base and arranged to clamp at least part of a blade in the viewing window.

In this way the viewing window allows the user to see the edge of the work piece before the blade engages the work piece. This means that the user can make sure both the first and second walls are engaging the work piece before the blade removes material. The user can see the longitudinal ridge of the tool from above. The longitudinal ridge shows the straight edge of the work piece, which is obscured by the tool. This helps the user align the tool with the work piece.

Preferably the base comprise a first end and a second end and the viewing window is between the first and second ends. The viewing window may be in the middle of the base which means that a portion of the base engages with the work piece before the blade. This means that the tool can be steadied by the work piece itself before the blade cuts the work piece.

Preferably the first and second walls are substantially perpendicular to each other.

Preferably the viewing window comprises at least one edge inclined with respect to the longitudinal axis. The viewing window may be inclined approximately 20 degrees with respect to the longitudinal axis. This means that the blade is angled at a shallow angle with respect to the work piece engages the work piece smoothly. This stops the blade juddering when the tool engages the work piece.

Preferably the depth of the viewing window the extends in the first and second surfaces at least halfway between the longitudinal ridge and an edge of the first and/or second wall remote from the longitudinal ridge. Optionally the viewing window can extend substantially to the edge of the first and/or second wall remote from the longitudinal ridge. Preferably the viewing window is symmetrical about the longitudinal axis.

Preferably the chamfering tool comprises a gate member mounted around the viewing window and the blade clamp is arranged to clamp against the gate member.

Preferably the chamfering tools comprises a handle mounted on the base either side of the longitudinal ridge. Preferably the handle is mounted adjacent to the viewing window. The handle may comprise a groove for receiving a user's digits. Placing the handle adjacent to the viewing window means that the handle is substantially in the middle of the chamfering tool. This means that the user can comfortably use the chamfering tool with one hand. The groove is ergonomic and suitable for receiving a thumb and a finger either side of the handle.

Preferably the blade clamp is arranged to clamp the blade substantially perpendicular to the longitudinal axis. This means that the user can more easily align the work piece with the tool. Preferably the blade clamp is arranged to clamp the blade such that the middle of the blade is aligned with the longitudinal axis. This means that blade will less likely to experience a turning moment when the blade engages the work piece and the blade will remain fixed with respect to the tool.

Preferably the blade clamp comprises a recessed portion for engaging at least two edges of a blade. This means blade is less likely to move with respect to the tool during use. Preferably the chamfering tool comprises a trapezoidal blade. The recess of the blade clamp can engage the two non-parallel sides of the trapezoidal blade. Additionally or alternatively the recess of the blade clamp engages edge opposite the blade edge of the trapezoidal blade.

Preferably the blade clamp comprises a tool free knob for clamping the blade. This means that the user can easily adjust and replace the blade.

Preferably the chamfering tool is configured to chamfer panels and the entire depth of an edge of the panel is visible in the viewing window.

### BRIEF DESCRIPTION OF THE DRAWINGS

Various other aspects and further embodiments are also described in the following detailed description and in the attached claims with reference to the accompanying drawings, in which:

FIG. 1 shows a perspective view of the chamfering tool;

FIG. 2 shows side view of the chamfering tool;

FIG. 3 shows a perspective view of the base of the chamfering tool;

FIG. 4 shows an underneath view of part of the blade clamp of the chamfering tool;

FIG. 5 shows a plan view of part of the chamfering tool;

FIG. 6 shows a perspective view of the chamfering tool; and

FIG. 7 shows a front end view of the chamfering tool engaging a work piece.

### DETAILED DESCRIPTION OF THE INVENTION

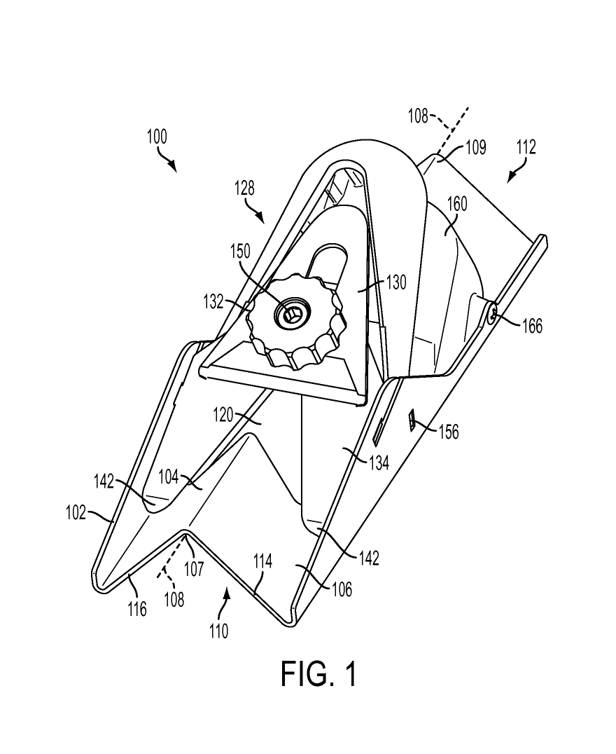

FIG. 1 shows a perspective view of a chamfering tool 100. The chamfering tool 100 comprises a base 102. The base 102 is generally elongate extending along a longitudinal axis 108. The base 102 has a first wall 104 and a second wall 106 which meet at and extend along the longitudinal axis 108.

In some embodiments the first and second walls 104, 106 are substantially perpendicular to each other. This means the first and second walls 104, 106 can engage a flat surface and an edge of a work piece which are perpendicular to each other. In other embodiments the angle between the first and second walls 104, 106 can be any suitable angle.

Typically the work piece is a panel P (see FIG. 7) such as a portion of drywall. Hereinafter the work piece will be referred to as a panel P although other objects with elongate edges could be used with the chamfering tool. The panel P comprises large flat surfaces and a thin edge.

The base 102 of the chamfering tool 100 comprises a bottom 110 and a top 112. The bottom 110 of the base 102 comprises first and second surfaces 114, 116 which meet and define a longitudinal recess 107. The first and second surfaces 114 and 116 are arranged to engage the flat surface of the panel and the edge of the panel. In use the bottom 110 of the base 102 will typically be facing downwards and the top 112 of the base 102 will be facing upwards.

As mentioned the first and second walls 104, 106 are perpendicular to each other and define a longitudinal ridge 109 and a longitudinal recess 107. The longitudinal recess 107 and ridge 109 are parallel to each other and parallel to the longitudinal axis 108. In some embodiments the longitudinal recess 107 is an internal corner or vertex defined by the intersection of the first and second walls 104, 106. In some embodiments the longitudinal ridge 109 is an external corner or vertex defined by the intersection of the first and second walls 104, 106.

The longitudinal ridge 109 extends along the base 102 on the top 112 of the base and provides a visual reference of the obscured corner of the panel P which is being chamfered. The walls 104, 106 are made from a sheet material such as metal. The walls 104, 106 can be made from any suitable material. The walls 104, 106 show the profile of the corner of the panel P underneath in use.

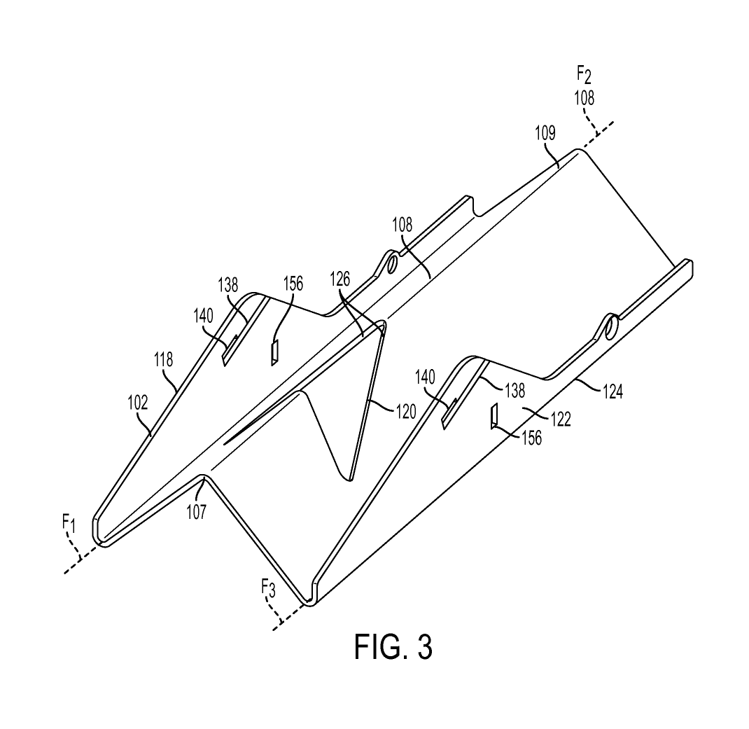

A viewing window 120 is cut out of the middle of the base 102. The viewing window 120 allows the user to see the panel P. The window 120 will now be described in further detail with respect to FIG. 3. FIG. 3 shows a perspective view of the base 102. The base 102 in some embodiments is constructed from a sheet material, such as sheet metal. The base 102 is folded along the three fold lines F₁, F₂, F₃. Folds along F₁, and F₃ require bending the sheet material up by 135 degrees. This defines two upward side walls 118, 122. Fold F₂ requires bending the sheet material down by 90 degrees. Fold F₂ runs along the same line as the longitudinal axis 108. Of course in other embodiments the angles the sheet material of the base 102 is bent through can be varied.

The viewing window 120 is stamped or cut out of the base 102. In some embodiments the viewing window 120 is stamped before the base 102 is folded. The viewing window 120 defines a large cut out from the base 102. This provides sufficient space to view the panel P when the chamfering tool 100 engages the panel P. The viewing window 120 extends at least halfway between the longitudinal ridge 109 and an edge 124 of the first or second wall 104, 106 distal from the longitudinal ridge 109. The viewing window 120 intersects the longitudinal ridge 109 and the longitudinal recess 107 between the ends of the base.

The viewing window 120 is sufficiently large enough to view the entire of an edge of the panel P when the first and second wall 104, 106 engage the panel P. A blade is mounted in the viewing window 120 but the viewing window 120 is sufficiently large enough to accommodate the blade and still provide visibility of the panel P to the user.

The viewing window 120 is substantially triangular in shape and is substantially symmetrical about the longitudinal axis 108. The viewing window 120 defines an inclined edge 126. The inclined edge 126 is inclined with respect to the longitudinal axis 108. In some embodiments the inclined edge 126 with respect to the longitudinal axis 108 by about 20 degrees. A shallow angle of 20 degrees provides a smooth cut on the panel P.

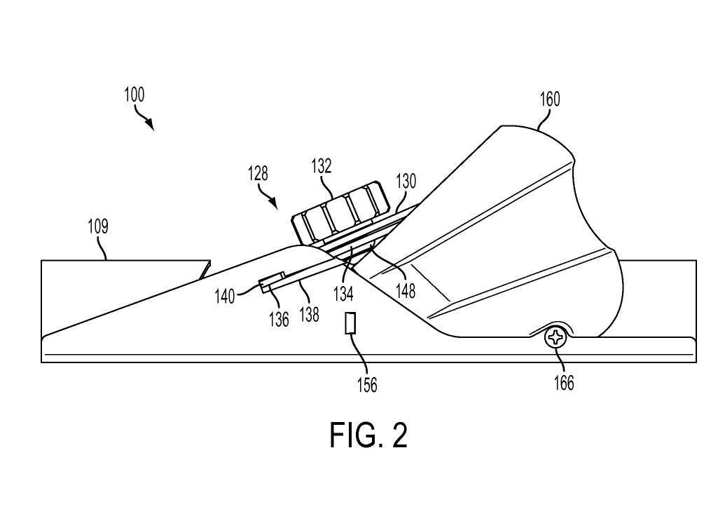

Returning to FIGS. 1 and 2, the chamfering tool comprises a blade clamp 128. FIG. 2 shows a side view of the chamfering tool 100. The blade clamp 128 is arranged to clamp the blade (not shown) to the chamfering tool 100. The blade clamp 128 comprises a clamping plate 130 and a tightening knob 132. The clamping plate 130 urges the blade against a gate member 134. The blade clamp 128 is arranged to mount the blade in the viewing window such that at least a portion of the blade intersects with the longitudinal ridge and recess 109, 107.

The gate member 134 will be briefly described in reference to FIGS. 2 and 5. FIG. 5 shows a plan view of the gate member 134. The gate member 134 is substantially flat and made from a sheet material such as metal. The gate member 134 is fixedly mounted to the base 102. The gate member 134 comprises a two projections 136 which engage with the base 102 in slots 138 and notch 140. The gate member 134 also comprises two feet 142 which engage with the topside of the first and second walls 104, 106. The feet 142 are folded downwardly such that the feet engage the upward side walls 118, 122 and the first and second walls 104, 106. The gate member 134 is mounted on the inclined edge 126 of the viewing window 120. The relative positions of the inclined edge 126 and the slots 138 cause the inclined edge 126 to urge the gate member 134 upwardly. In this way the two projections 136 slide down the slots 138 and are urged into the notches 140 in the upward side walls 118, 122. This means that the gate member 134 is held in place with respect to the base 102. The gate member 134 comprises a “V” shaped cut out 144 to align with the viewing window 120. The V-shaped cut out 144 means that the gate member 134 does not obscure the viewing window 120.

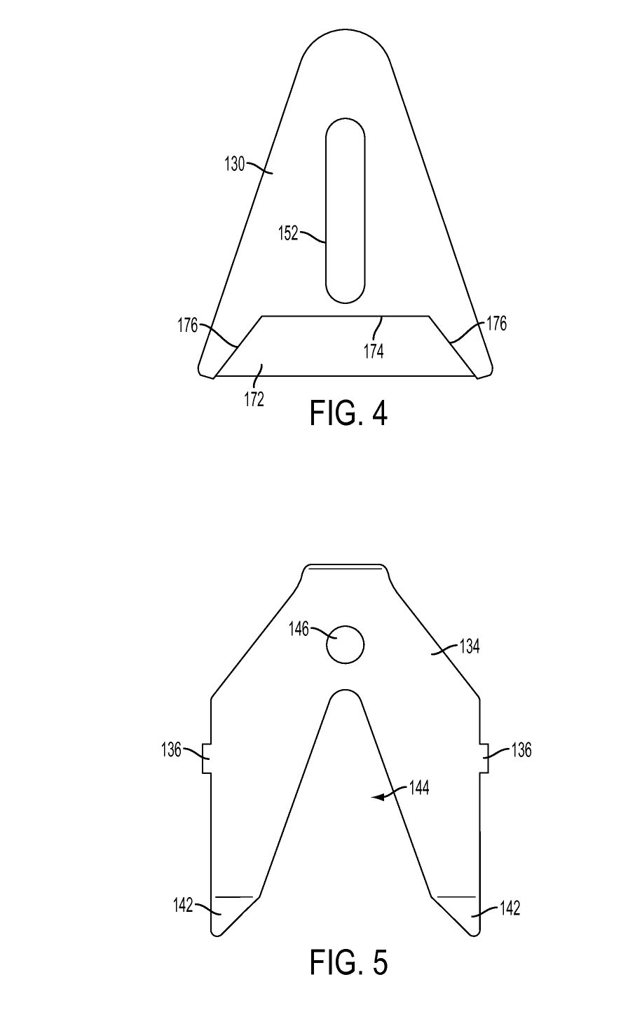

The gate member 134 comprises a circular hole 146 for receiving a threaded bolt 150. The head 148 of the threaded bolt 150 is adjacent to the underside of the gate member 134. The threaded bolt 150 projects through a slot 152 (as shown in FIG. 4) in the clamping plate 130 and the tightening knob 132 is threadedly mounted onto the threaded bolt 150.

The blade clamp 128 can be tightened and loosened by hand using the tightening knob 132. The tightening knob 132 does not require a tool for tightening or loosening the blade clamp 128. In some embodiments the tightening knob 132 can be any means suitable to tighten and loosen the blade clamp 128 without a tool. The slot 152 allows the clamping plate 130 to be moved and clamped in different positions relative to the base 102. In this way the blade can be set at different relative positions in the viewing window 120 and different depth cuts can be achieved.

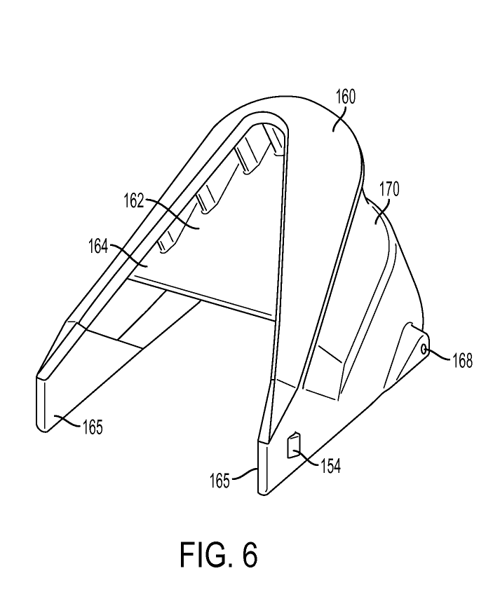

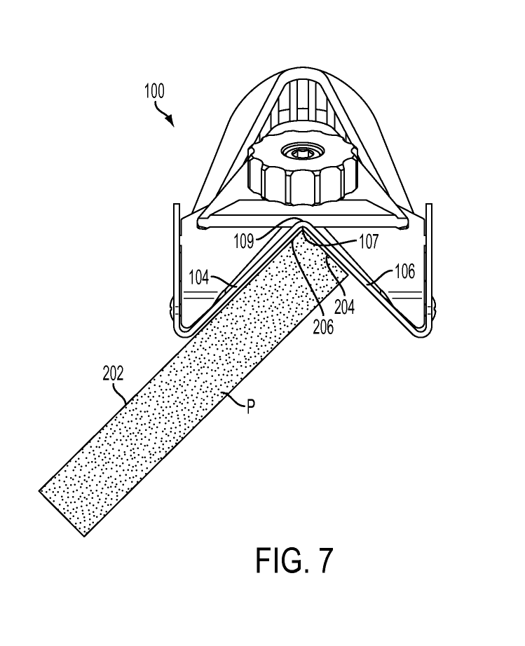

A handle 160 is mounted on the base 102. The handle 160 will now be discussed in further depth with respect to FIGS. 1 and 6. FIG. 6 shows a perspective view of the handle 160. The handle 160 comprises a general V-shaped cross section to provide a reciprocal recess 162 for receiving the gate member 134 and the clamping plate 130. The surface 164 of the recess 162 is inclined at the same angle with respect to the longitudinal axis 108 as the inclined surface 126 of the viewing window 120. The handle 160 is mounted on the base 102 either side of the longitudinal ridge 109 on the top 112 of the base 102. The handle 160 comprises projections 154 in two arm portions 165. The projections 154 engage with reciprocal projection receiving holes 156 in the upward side walls 118, 122 of the base 102. The projections 154 clip into the projection receiving holes 156. The handle 160 is made from a resilient material such as a plastic material. The arms 165 of the handle 160 are biased outwardly such that the arms 165 are squeezed together to insert the projections 154 into the holes 156. Once the projections 154 are inserted in the holes 156, the arms 165 urge the projections outwardly fixing the handle 160 to the base 102. The handle 160 is also fixed to the base by screws 166 and screw holes 168.

The handle 160 comprises an outer groove 170. The outer groove 170 extends substantially along the entire outer surface of the handle 160. The outer groove 170 is ergonomically adapted to receive digits of a user. In some embodiments the groove 170 receives a user's thumb on one side of the longitudinal axis 108 and a user's finger on the other side of the longitudinal axis 108. The handle 160 is adjacent the viewing window 120. The handle 160 and the viewing window 120 are mounted along the longitudinal ridge 109 between the ends of the base 102. Since both the viewing window 120 and the handle 160 are mounted in the middle of the base 102, the centre of gravity of the chamfering tool 100 is closer to the handle. This means that the tool can be operated with one hand if necessary.

In some embodiments, the clamping plate 130 comprises a recess for receiving the blade. In other embodiments the clamping plate 130 is flat and the blade is sandwiched between the clamping plate 130 and the gate member 134.

The recess 172 will now be discussed in reference to FIG. 4. FIG. 4 shows an underneath plan view of the clamping plate 130. The recess 172 guides the user when the installing or replacing the blade. In some embodiments the chamfering tool 100 uses trapezoidal blades. Of course, in other embodiments other shaped blades can be used. In some embodiments a lip 174 of the recess 172 engages with a parallel edge of the blade opposite the blade edge. In this way the lip 174 orientates the blade edge perpendicular to the longitudinal axis 108.

In other embodiments, and as shown in FIG. 4, the recess 172 is configured to engage with a parallel edge of the blade opposite the blade edge with lip 174 and the two non-parallel edges with side lips 176. Engaging the blade at sides as well stops sideways movement of the blade in the blade clamp 128. When a blade is mounted flush against lip 184 and side lips 176, the sharp blade edge extends beyond the clamping plate 130.

By providing a recess 172 with a predetermined position for locating the blade, the user can easily install the blade. In some embodiments the recess is arranged such that the middle of the blade is mounted in line with the longitudinal axis 108. The blade is also orientated substantially perpendicular to the longitudinal axis 108. In this way the blade does not experience a turning moment when the blade engages the panel and the blade is less likely to move out of place.

In other embodiments the recess is replaced with two positioning pegs (not shown) for engaging with two cut out portions on trapezoidal blades.

Use of the chamfering tools will now be briefly discussed with respect to FIG. 7. FIG. 7 shows an end view of the chamfering tool 100 engaging a panel P. The first wall 104 engages the large flat surface 202 of the panel P and the second wall 106 engages the thin edge 204 of the panel P. The corner 206 of the panel P engages with the longitudinal groove 107. A portion of the base 102 extends in front of the viewing window 120 and the blade. This means that the chamfering tool 100 can be located on the panel P before a cut is made. This helps steady and align the chamfering tool before cutting. The longitudinal ridge 109 provides a visual reference of the corner 206, obscured by the tool, which is being chamfered. This helps the user keep the tool straight when cutting the panel. The viewing window 120 also permits the user to see that the first and second surfaces 114, 116 are engaging the panel. The depth of cut can be adjusted by adjust the position of the blade with respect to the gate member 134 by loosening the blade clamp 128.

Embodiments of the present invention have been discussed with particular reference to the examples illustrated. However it will be appreciated that variations and modifications may be made to the examples described within the scope of the invention.

1. A chamfering tool comprising:
a base having first and second walls meeting each other along a longitudinal axis and defining a longitudinal recess along the bottom of the base for engaging a work piece and a longitudinal ridge along the top of the base;
a viewing window in the base for viewing the work piece, the viewing window intersecting the longitudinal recess and the longitudinal ridge; and
a blade clamp mounted on the base and arranged to clamp at least part of a blade in the viewing window.

2. A chamfering tool according to claim 1 wherein the base comprises a first end and a second end and the viewing window is between the first and second ends.

3. A chamfering tool according to claim 1 wherein the first and second walls are substantially perpendicular to each other.

4. A chamfering tool according to claim 1 wherein the viewing window comprises at least one edge inclined with respect to the longitudinal axis.

5. A chamfering tool according to claim 4 wherein the at least one edge of the viewing window is inclined approximately 20 degrees with respect to the longitudinal axis.

6. A chamfering tool according to claim 1 wherein the depth of the viewing window the extends in the first and second surfaces at least halfway between the longitudinal ridge and an edge of the first and/or second wall remote from the longitudinal ridge.

7. A chamfering tool according to claim 1 wherein the chamfering tool comprises a gate member mounted around the viewing window and the blade clamp is arranged to clamp against the gate member.

8. A chamfering tool according to claim 1 wherein the chamfering tool comprises a handle mounted on the base either side of the longitudinal ridge.

9. A chamfering tool according to claim 8 wherein the handle is mounted adjacent to the viewing window.

10. A chamfering tool according to claim 8 wherein the handle comprises a groove for receiving a user's digits.

11. A chamfering tool according to claim 1 wherein the blade clamp is arranged to clamp the blade substantially perpendicular to the longitudinal axis.

12. A chamfering tool according to claim 1 wherein the blade clamp comprises a recessed portion for engaging at least two edges of a blade.

13. A chamfering tool according to claim 1 wherein the chamfering tool comprises a trapezoidal blade.

14. A chamfering tool according to claim 1 wherein the blade clamp comprises a tool free knob for clamping the blade.

15. A chamfering tool according to claim 1 wherein the chamfering tool is configured to chamfer panels and the entire depth of an edge of the panel is visible in the viewing window.
